(19) United States
(12) Patent Application Publication
(10) Pub. No.: US 2021/0035177 A1
(43) Pub. Date: Feb. 4, 2021

(54) METHOD OF CONTROLLING SCREEN GENERATING SERVER, AND PRODUCT INFORMATION PROVIDING SYSTEM

(71) Applicant: CANON KABUSHIKI KAISHA, Tokyo (JP)

(72) Inventor: Hiroki Hachiya, Kawasaki-shi (JP)

(21) Appl. No.: 16/935,729

(22) Filed: Jul. 22, 2020

(30) Foreign Application Priority Data
Jul. 29, 2019 (JP) 2019-139124

(51) Int. Cl. G06Q 30/06; H04L 29/08; G06Q 10/08; G06F 16/958; G06F 16/955

(52) U.S. Cl. CPC G06Q 30/0623; H04L 67/02; G06Q 10/087; G06F 16/9566; G06Q 30/0633; G06F 16/958; G06Q 30/0641

(57) ABSTRACT

The present invention provides a method and program of controlling the screen generating server, which achieve a support service assisting system improving user convenience. To achieve this, on a support screen displayed in the case where a remaining ink amount in a printer becomes low, a name of a distributor EC site and a price offered by the distributor are displayed next to an area displaying a price offered by a vendor.

### BACKGROUND OF THE INVENTION

### Field of the Invention

The present invention relates to a method of controlling a screen generating server that generates a WEB page in response to an access request from a client terminal, and a product information providing system.

### Description of the Related Art

Japanese Patent Laid-Open No. 2005-059303 discloses a support service system in which a client terminal reports device type information and remaining ink amounts of a printer to a server and the server generates screen information of an ink tank sales site depending on the reported information and transmits the screen information to the client terminal. Moreover, the support service system of Japanese Patent Laid-Open No. 2005-059303 can display an ink tank with a low remaining ink amount in a highlighted manner.

### SUMMARY OF THE INVENTION

The support service system of Japanese Patent Laid-Open No. 2005-059303 displays only the information of the vendor's own sales site. However, some users perform additional searching with a computer or the like to compare prices on other sales sites. In this case, user convenience is sometimes poor because the user has to perform extra work or may commit an operation error in the searching or the searching is wasted in the case where the product is unavailable.

Accordingly, the present invention provides a method of controlling the screen generating server, and a product information providing system that improve user convenience.

A method of controlling a screen generating server in the present invention is thus a method of controlling a screen generating server that generates a WEB page based on a request from a client terminal, comprising: a first obtaining step of obtaining a parameter relating to a predetermined device from the client terminal in the case where the device is in a predetermined state; a second obtaining step of obtaining first product information relating to the device and access information for obtaining information in a distributor site of the device, from a database storing information relating to the device, based on the parameter obtained in the first obtaining step; a third obtaining step of obtaining second product information by using the access information, the second product information relating to the device and corresponding to a product specified by the first product information obtained in the second obtaining step; a generating step of generating the WEB page based on the first product information obtained in the second obtaining step and the second product information obtained in the third obtaining step; and a transmitting step of transmitting the generated WEB page to the client terminal.

The present invention can provide a method of controlling the screen generating server, and a product information providing system that improve user convenience.

Further features of the present invention will become apparent from the following description of exemplary embodiments with reference to the attached drawings.

### BRIEF DESCRIPTION OF THE DRAWINGS

FIG. 1 is an overall configuration diagram illustrating a support service assisting system;

FIG. 2 is a diagram illustrating parameter conversion tables;

FIG. 3 is a block diagram illustrating a hardware configuration of a client terminal;

FIG. 4 is a view illustrating a status monitor screen displayed in the client terminal;

FIG. 5 is a diagram illustrating a sequence in the case where a remaining ink amount in a printer is low;

FIG. 6 is a view illustrating support screens displayed in the case where a WEB support button is pressed;

FIG. 7 is a diagram illustrating a sequence in the case where the remaining ink amount in the printer becomes low;

FIG. 8A is a view illustrating a support screen displayed in the case where the WEB support button is pressed;

FIG. 8B is a view illustrating a support screen displayed in the case where the WEB support button is pressed;

FIG. 9 is a diagram illustrating a sequence in the case where the remaining ink amount in the printer becomes low; and

FIG. 10 is a view illustrating a support screen displayed in the case where the WEB support button is pressed.

### DESCRIPTION OF THE EMBODIMENTS

### First Embodiment

A first embodiment of the present invention is described below with reference to the drawings.

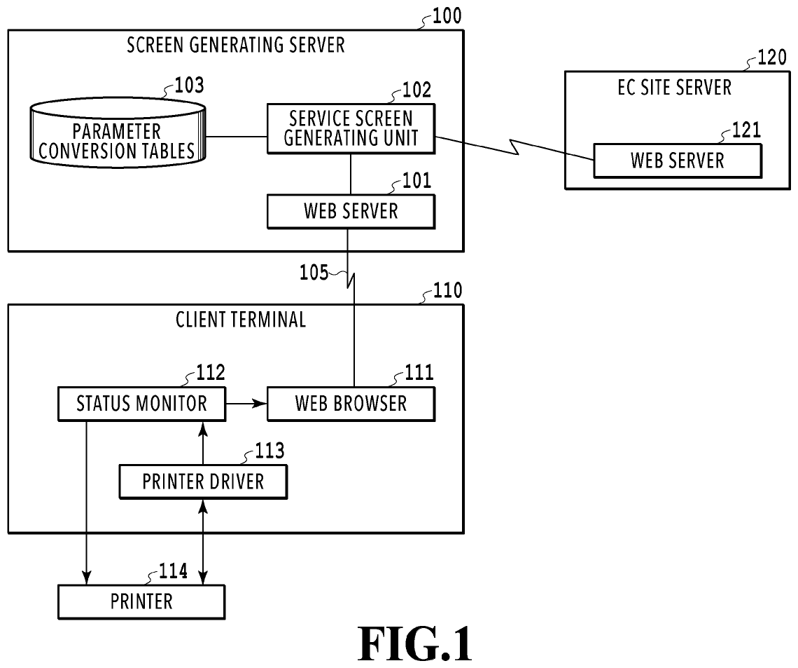

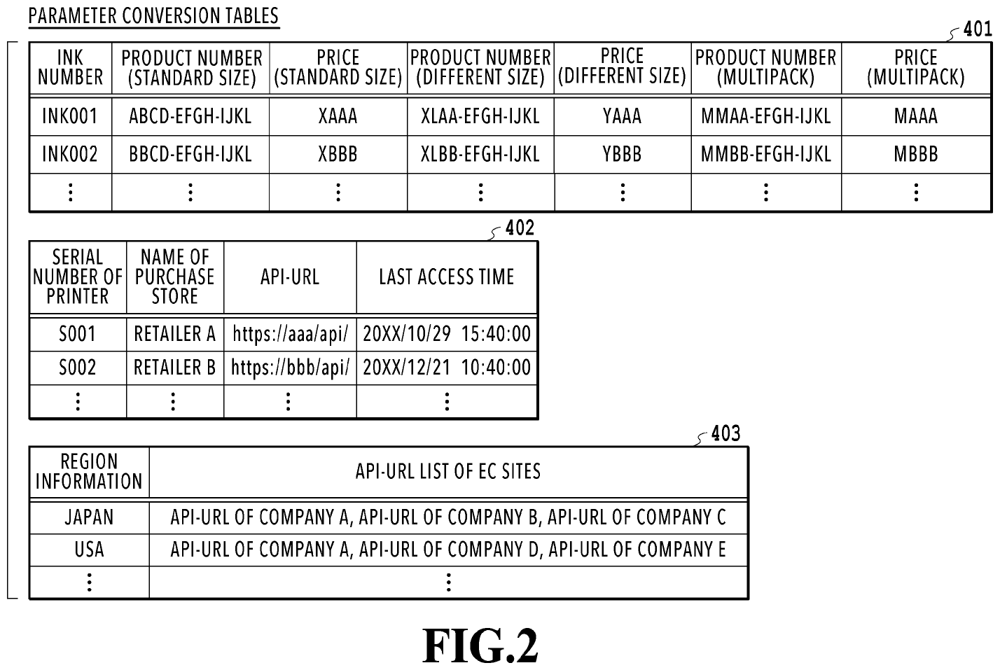

FIG. 1 is an overall configuration diagram illustrating a support service assisting system in the embodiment and FIG. 2 is a view illustrating parameter conversion tables 103. The support service assisting system includes a screen generating server 100 and a client terminal 110 connected to the screen generating server 100 via a network. The screen generating server 100 is connected to multiple sales site servers (EC site servers) 120 via a network. Note that, although only one EC site server 120 is illustrated in FIG. 1 for simplification, the screen generating server 100 is actually capable of connecting to multiple EC site servers 120. The screen generating server 100 includes a WEB server 101, a service screen generating unit 102, and the parameter conversion tables 103. The client terminal 110 includes a status monitor 112, a WEB browser 111, and a printer driver 113. The WEB server 101 of the screen generating server 100 and the WEB browser 111 of the client terminal 110 are connected to each other via a network 105.

The network 105 is the Internet, a local area network (LAN), or the like and enables communication between the aforementioned servers. The service screen generating unit 102 can communicate with the EC site server 120 and obtain information on products sold on the EC site.

The parameter conversion tables 103 are data tables stored in a database and are multiple tables having information for converting parameters received from the client terminal 110 to different parameters. The parameter conversion tables 103 include three tables of an ink number conversion table 401, a serial number conversion table 402, and a region information conversion table 403.

The ink number conversion table 401 is a table in which an ink number (unique management number), product numbers (JAN codes or the like), and the prices of an ink offered by a vendor being a manufacturer of a printer are linked with one another. The serial number conversion table 402 is a table in which a serial number of a printer 114 and a product information obtaining application programming interface URL (hereafter referred to as API-URL) of a printer purchase shop that is access information are linked with each other. The serial number conversion table 402 is generated by registering the serial number of the printer 114, the name of the printer purchase shop, and the like in the event where the printer is purchased. The region information conversion table 403 is a table in which region information (country information) determined by a printer driver) and a combination of API-URLs of EC sites being target in each region are linked with each other. The information such as the ink number and the price in these tables is registered in advance as master data.

The service screen generating unit 102 generates a WEB page on the WEB server in response to an access request to the WEB site from the client terminal 110, based on information from the parameter conversion tables 103, the EC site server 120, and the client terminal 110.

At least one device is connected to the client terminal 110 wirelessly or via wires and the support service assisting system of the embodiment provides a support service relating to the device connected to the client terminal 110. In the embodiment, an example in which the printer 114 is connected to the client terminal 110 is described. Specifically, an inkjet printer employing an inkjet recording method, a laser beam printer employing an electrophotographic method, or the like corresponds to the printer 114. The printer 114 is connected to the status monitor 112 via the printer driver 113.

The WEB browser 111 obtains screen information from the WEB server 101 operating on the screen generating server 100, via the network 105. The screen information in the embodiment is written in, for example, HTML and the WEB browser 111 displays a predetermined screen based on a HTML file obtained from the WEB server 101.

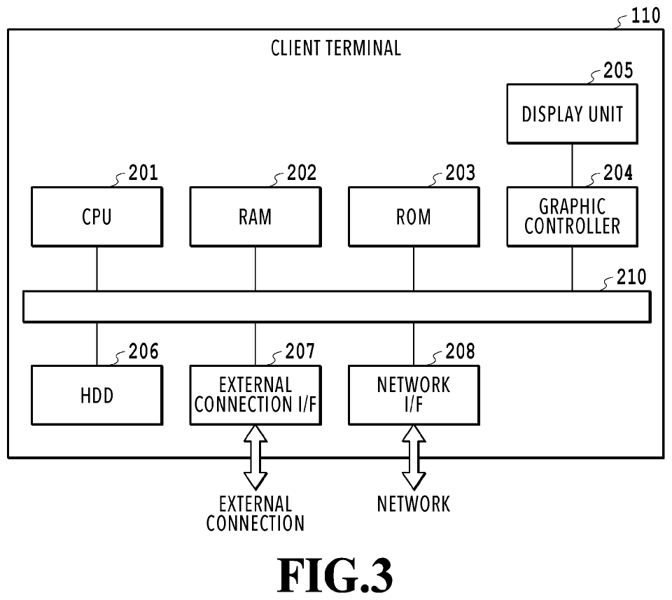

The status monitor 112 obtains a state of the printer 114 through communication with the printer 114 via the printer driver 113 and through direct communication with the printer 114. Moreover, the status monitor 112 has a function of displaying the state of the printer 114 on a display unit (205 in FIG. 3 to be described later). Note that the status monitor 112 is activated in the case where a predetermined event occurs in the printer 114. The status monitor 112 is activated, for example, in the case where a remaining ink amount in the printer 114 is determined to be low or paper jam is determined to have occurred in the printer 114 based on the information obtained from the printer 114.

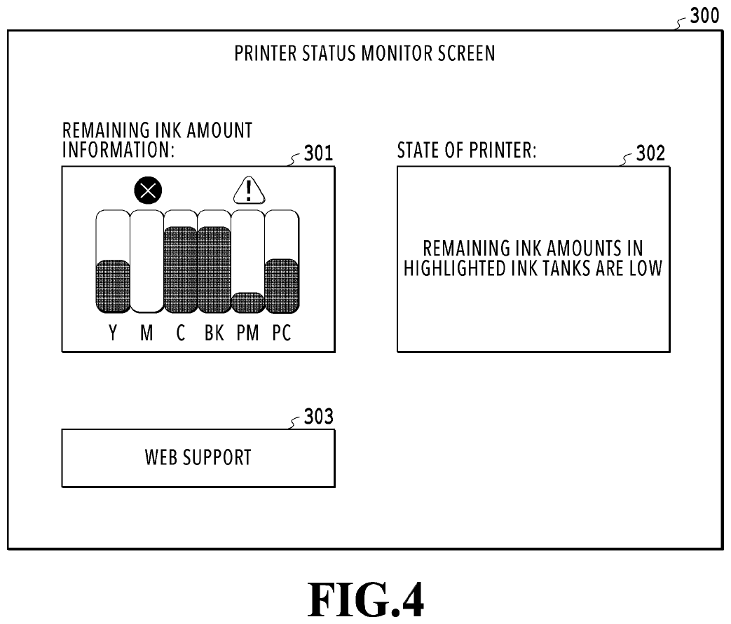

Then, the status monitor 112 displays the state of the printer 114 and also displays information on replenishment of the ink and information for solving an error such as paper jam on the display unit (205 in FIG. 3 to be described later). The status monitor 112 can be activated not only in the case where the predetermined event occurs but also at any timing in response to input of a predetermined operation made by the user. Moreover, the status monitor 112 has a function of accessing a site that sells a replacement ink tank. For example, in the case where a user presses a button (303 in FIG. 4 to be described later) for using a Web service to be described later, the status monitor 112 notifies the screen generating server 100 of information such as a printer type and the remaining ink amount via the WEB browser 111.

The EC site server 120 is a server of an EC site provided by the printer purchase shop. The EC site server 120 has a WEB server 121 and has a function of returning, in response to searching made by using a retrieval key such as a product number from outside as API, corresponding product information in the EC site as a response.

FIG. 3 is a block diagram illustrating a hardware configuration of the client terminal 110 in the embodiment. The client terminal 110 includes a CPU 201, a RAM 202, a ROM 203, a graphic controller 204, the display unit 205, and a hard disk drive (HDD) 206. Furthermore, the client terminal 110 includes an external connection interface (hereafter, interface is referred to as “I/F”) 207, and a network I/F 208 and the components of the client terminal 110 are connected via a bus 210 to be capable of communicating with one another. The CPU 201 is formed of a computation circuit and controls the client terminal 110 as a whole. The CPU 201 loads programs stored in the ROM 203 or the HDD 206 onto the RAM 202 and executes various processes. The ROM 203 stores a system program used to control the client terminal 110 and the like.

The graphic controller 204 generates a screen to be displayed on the display unit 205. The HDD 206 has a function as a storage region and stores an application program and the like that execute various processes. Note that the HDD 206 is an example of a storage device and the storage device may be formed of a solid state drive (SSD) or the like instead of the HDD. The external connection I/F 207 is an interface used to connect various devices to the client terminal 110. For example, a display, a keyboard, a mouse, and like can be connected to the client terminal 110 via the external connection I/F 207.

The network I/F 208 communicates with the screen generating server 100 and the like via the network based on the control of the CPU 201. The hardware configuration of the client terminal 110 illustrated in FIG. 3 is a common configuration as an information processing apparatus. Accordingly, the screen generating server 100 and the EC site server 120 can also be implemented by information processing apparatuses having the hardware configuration illustrated in FIG. 3. Moreover, although each server is formed of one server (information processing apparatus) in FIG. 3, in the embodiment, multiple servers may operate while cooperating with one another to execute functions of one server in FIG. 3. Specifically, the functions of the screen generating server 100 may be executed by a server system including multiple servers.

FIG. 4 is a view illustrating a printer status monitor screen 300 that is displayed by the printer driver 113 in the client terminal 110 in the case where the remaining ink amount becomes low. The printer status monitor screen 300 includes remaining ink amount information 301, a state of printer 302, and a WEB support button 303. The remaining ink amount information 301 illustrates the remaining ink amounts of the respective colors in the printer 114 by using a diagram, in which, in the case where the remaining ink amount of any color falls below a predetermined amount, sign of x or ! is added to a portion of the concerned color as in FIG. 4 and a message that the remaining ink amount is low is displayed in the state of printer 302. Then, in the case where the user presses the WEB support button 303, the status monitor 112 (see FIG. 1) transmits the parameters (serial number, ink number, remaining ink amount information, device type information, region information) to the screen generating server 100.

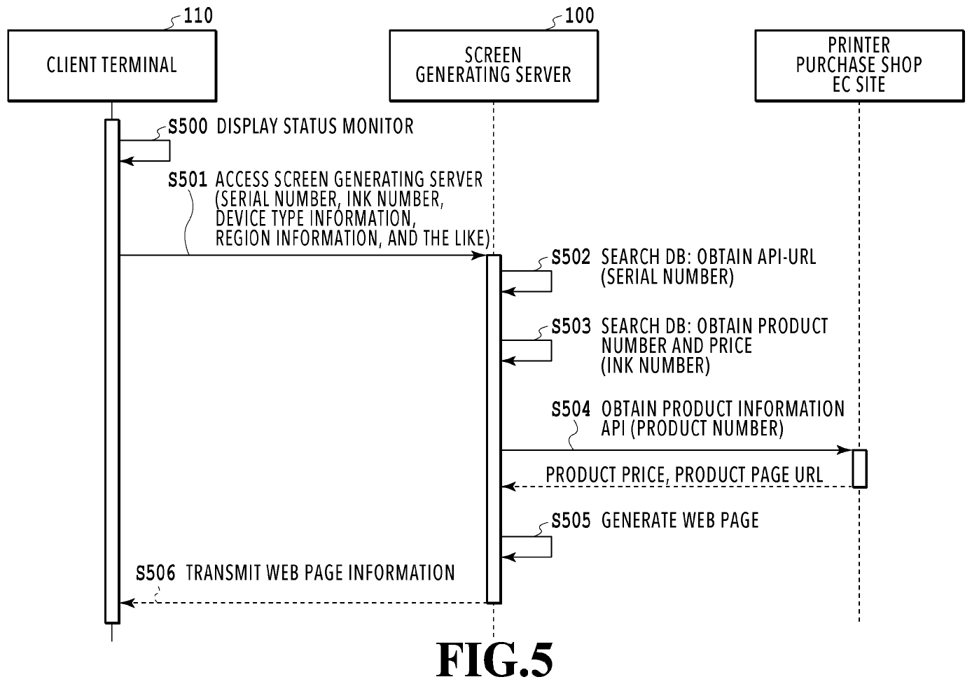

FIG. 5 is a view illustrating a sequence in the case where the remaining ink amount in the printer 114 becomes low in the support service assisting system of embodiment. The CPU 201 of the screen generating server 100 mainly loads a program code stored in the HDD 206 onto the RAM 202 and executes the program code to perform the sequence of FIG. 5. Alternatively, part or all of functions in steps of FIG. 5 may be implemented by hardware such as an ASIC or an electronic circuit. Note that sign “S” in description of each process means step in the flowchart (the same applies hereafter in the description).

In the case where the remaining ink amount in the printer 114 becomes low, the printer status monitor screen is displayed in the client terminal 110 in S500. Thereafter, in the case where the WEB support button 303 on the printer status monitor screen is pressed, the status monitor 112 (see FIG. 1) of the client terminal 110 accesses the screen generating server 100 in S501. In this case, the client terminal 110 sends the serial number, the ink number, the device type information, and the region information of the printer 114 as parameters and the screen generating server 100 receives these parameters.

In S502, the screen generating server 100 searches the serial number conversion table 402 of the parameter conversion tables 103 by using the received serial number of the printer 114 as a retrieval key and obtains the API-URL of the printer purchase shop. Moreover, in S503, the screen generating server 100 searches the ink number conversion table 401 of the parameter conversion tables 103 by using the received ink number as a retrieval key and obtains the product number and the price of the ink.

Thereafter, in S504, the screen generating server 100 executes the API-URL of the printer purchase shop EC site while adding the product number as a parameter and obtains product information (mainly, a product price, a URL of a product page, and the like) in the printer purchase shop EC site. In the case where there are multiple prices for the same product, the screen generating server 100 sorts the prices in the ascending order, compares the prices with the price offered by the vendor of the printer in the ink number conversion table 401, and extracts pieces of data whose price differences are within a certain percentage as processing targets. Then, in S505, the screen generating server 100 generates a support screen that is a WEB screen based on the extracted product information and the information received from the client terminal 110. Thereafter, in S506, the screen generating server 100 transmits the generated WEB page information to the client terminal 110.

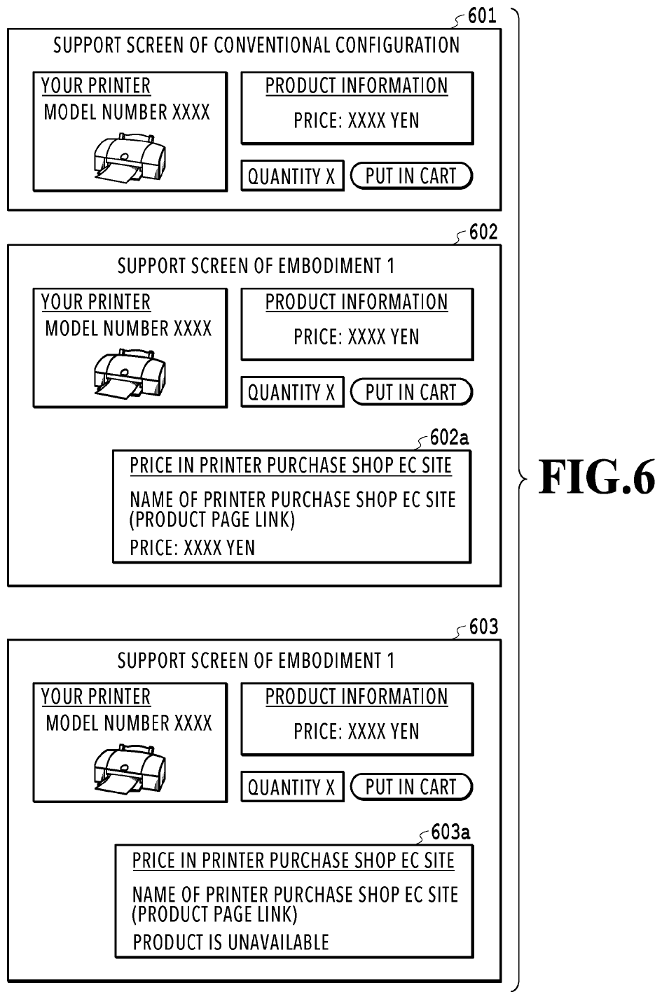

FIG. 6 is a view illustrating support screens displayed in the case where the ink amount becomes low and the WEB support button 303 is pressed. A support screen 601 is a conventional support screen and support screens 602, 603 are support screens of the embodiment. In the conventional support screen 601, there are arranged client device type information, product information, a price of an ink offered by a vendor, a quantity entry field, and a put-in-cart button. The information obtained from the ink number conversion table 401 is displayed as the client device type information, the product information, and the price of the ink offered by the vendor in the support screen 601. Note that the support screen 601 displays the information obtained from the parameter conversion tables managed in the screen generating server 100 and includes no information from the printer purchase shop EC site as described in FIG. 5. In the conventional support screen 601, it is possible to purchase the product by inputting a quantity in the quantity entry field and pressing the put-in-cart button.

In contrast to such a conventional support screen, in the embodiment, an area 602a that displays the name of the printer purchase shop site and the price offered by the printer purchase shop is arranged next to the area displaying the price offered by the vendor, in addition to the other pieces of information provided in the conventional support screen. Moreover, the name of the printer purchase shop EC site is a link to a product page in the printer purchase shop EC site and pressing the name of the printer purchase shop EC site enables page transition.

Meanwhile, in the case where it is found that the searched product is sold out or is unavailable in the printer purchase shop EC site in the obtaining of the product information, an area 603a that notifies the user that there is no product is displayed on the support screen. In this case, the screen generating server 100 obtains information on whether the product is available and generates the WEB page that is the support screen.

Note that, although the description is given by using the printer 114 connected to the client terminal 110 as an example in the embodiment, the present invention is not limited to this and may be applied to other devices using consumables.

As described above, the name of a sales shop EC site and the price offered by the distributor are displayed to be arranged next to the area displaying the price offered by the vendor, on the support screen displayed in the case where the remaining ink amount in the printer becomes low. This can provide a screen generating server, a method of controlling the screen generating server, a program, and a product information providing system that achieve a support service assisting system improving the user convenience.

### Second Embodiment

A second embodiment of the present invention is described below with reference to the drawings. Note that the basic configuration of the embodiment is the same as that of the first embodiment and characteristic configurations are thus described below.

In the first embodiment, the screen generating server 100 displays only the same product as the product with the ink number received from the client terminal 110. However, there are products of the same ink varying in volumes or a sales form of multipack in which inks of multiple colors are grouped as a set. In the embodiment, such products other than the same product are also displayed in the service screen.

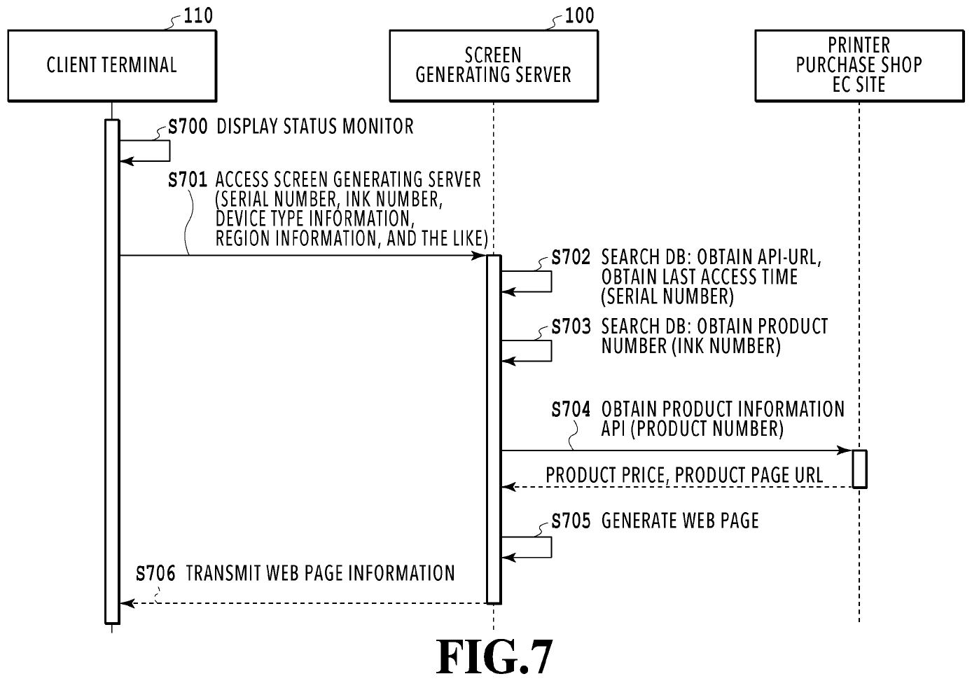

FIG. 7 is a diagram illustrating a sequence in the case where the remaining ink amount in the printer 114 becomes low in a support service assisting system of the embodiment. First, description is given of the case where normal size ink products are used and the remaining amount of one of the inks of multiple colors becomes low. The processing up to the point where the client terminal 110 accesses the screen generating server 100 is the same as that in the first embodiment. In S702, the screen generating server 100 searches the serial number conversion table 402 of the parameter conversion tables 103 by using the serial number of the received printer 114 as the retrieval key and obtains the API-URL and the last access time of the printer purchase shop. Note that the configuration may be such that the last access time is stored in a cookie of the browser and thus stored time is used.

Moreover, in S703, the screen generating server 100 searches the ink number conversion table 401 of the parameter conversion tables 103 by using the received ink number as a retrieval key and obtains the product number and the price of the ink. In this case, if the last access time is within a certain period (for example, seven days), the screen generating server 100 determines that the user is a user who frequently uses the printer and obtains the product number of a XL size version product in addition to the product number of the normal size ink product in the searching of the ink number conversion table 401. Then, in S704, the screen generating server 100 executes the API of the printer purchase shop EC site for both of the product number of the normal size product and the product number of the XL size product and obtains information on each product. Next, in S705, the screen generating server 100 generates a support screen including information on both of the normal size product and the XL size product. Thereafter, in S706, the screen generating server 100 transmits the generated WEB page information to the client terminal 110.

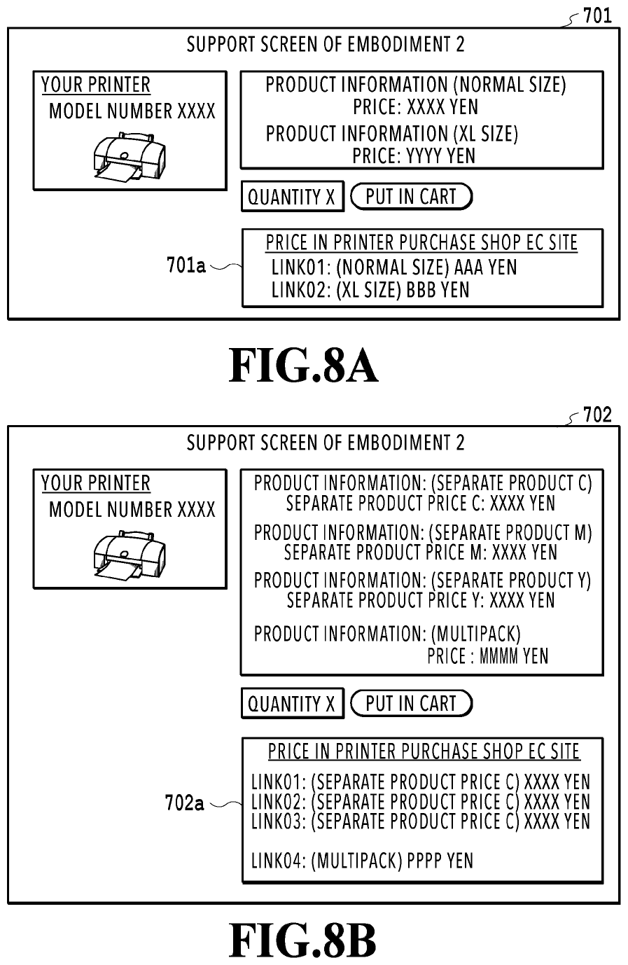

FIGS. 8A and 8B are views illustrating support screens displayed in the case where the WEB support button 303 is pressed in the embodiment. A support screen 701 in FIG. 8A is a view illustrating the generated support screen including the information on both of the normal size product and the XL size product. An area 701a displaying the name of the printer purchase shop EC site and the prices of both of the normal size product and the XL size product offered by the printer purchase shop is arranged next to the area displaying the prices of both of the normal size product and the XL size product offered by the vendor.

Note that, in the case where the user with low usage frequency is using the ink product of XL size, the screen generating server 100 may generate a support screen additionally displaying the normal size product.

Next, description is given of the case where the remaining ink amounts of multiple inks become low simultaneously. Assume a case where the screen generating server 100 searches the ink number conversion table 401 of the parameter conversion tables 103 and obtains the product number and the price in S703. In this case, if the number of inks of low remaining amounts is equal to or greater than a certain number (for example, three colors or more), the screen generating server 100 obtains the product numbers of separate products and the product number of a multipack version product. Then, in S704, the screen generating server 100 executes the API of the printer purchase shop EC site for the product numbers of the normal separate products and the product number of the multipack version product and obtains information on each product. Then, in S705, the screen generating server 100 generates a support screen including information on the normal separate products and the multipack version product.

A support screen 702 in FIG. 8B is a view illustrating the generated support screen including the information on the normal separate products and the multipack version product. An area 702a displaying the name of the printer purchase shop EC site and the prices of the normal separate products and the multipack version product offered by the printer purchase shop is arranged next to the area displaying the prices of the normal separate products and the multipack version product offered by the vendor.

Note that, although the case of the XL size product and the case of the multipack product are described separately in the embodiment, these cases may be combined and the user convenience can be improved also in this case.

### Third Embodiment

A third embodiment of the present invention is described below with reference to the drawings. Note that the basic configuration of the embodiment is the same as that of the first embodiment and characteristic configurations are thus described below.

In the first embodiment, description is given of the example in which the screen generating server 100 displays the printer purchase shop EC site as the additionally-displayed EC site information. However, in this embodiment, EC site information on multiple distributors other than the printer purchase shop is displayed in the support screen.

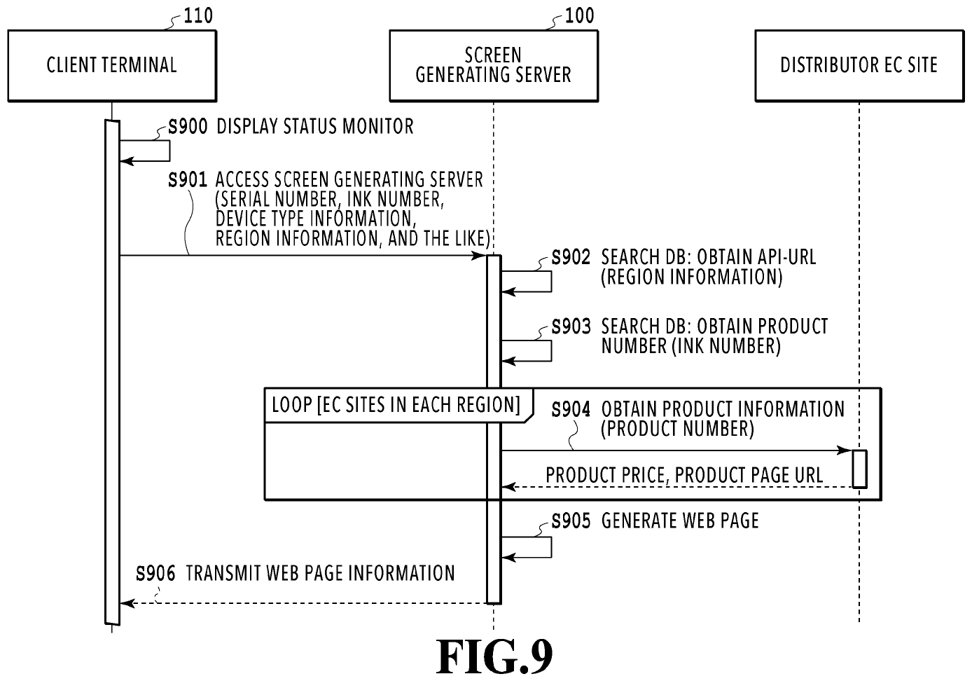

FIG. 9 is a view illustrating a sequence in the case where the remaining ink amount in the printer 114 becomes low in the support service assisting system of the embodiment. The processing up to the point where the client terminal 110 accesses the screen generating server 100 is the same as that in the first embodiment. In S902, the screen generating server 100 searches the region information conversion table 403 of the parameter conversion tables 103 by using the received region information as the retrieval key and obtains API-URLs of multiple EC sites in the region. The region information conversion table 403 may hold a combination of EC sites in advance. In S903, the screen generating server 100 searches the ink number conversion table 401 of the parameter conversion tables 103 by using the received ink number as the retrieval key and obtains the product number and the price of the ink. Thereafter, in S904, the screen generating server 100 repeatedly obtains the product information as many times as the number of the held API-URLs. Then, in S905, the screen generating server 100 generates the support screen by using the obtained product information in the multiple EC sites. In S906, the screen generating server 100 transmits the generated WEB page information to the client terminal 110.

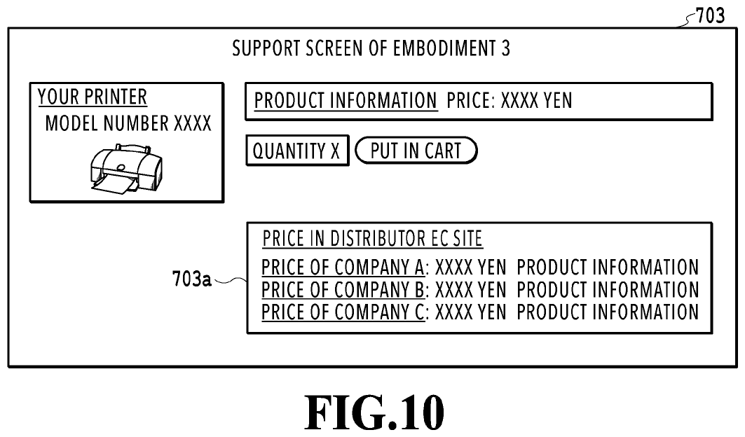

FIG. 10 is a view illustrating a support screen 703 displayed in the case where the WEB support button 303 is pressed in the embodiment. The support screen 703 is a view illustrating the generated support screen including the product information in the multiple EC sites. An area 703a displaying the names of the multiple distributor sites and the prices therein is arranged next to the area displaying the price of the product offered by the vendor.

### Other Embodiments

The present invention can also be implemented by supplying a program that implements one or more of the functions in the aforementioned embodiments to a system or an apparatus via a network or a storage medium and causing one or more of processors in the system or a computer of the apparatus to perform processing of reading and executing the program. Moreover, the present invention can be implemented by a circuit (for example, ASIC) that implements one or more of the functions.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-139124 filed Jul. 29, 2019, which is hereby incorporated by reference wherein in its entirety.

What is claimed is:

1. A method of controlling a screen generating server that generates a WEB page based on a request from a client terminal, comprising:
a first obtaining step of obtaining a parameter relating to a predetermined device from the client terminal in the case where the device is in a predetermined state;
a second obtaining step of obtaining first product information relating to the device and access information for obtaining information in a distributor site of the device, from a database storing information relating to the device, based on the parameter obtained in the first obtaining step;
a third obtaining step of obtaining second product information by using the access information, the second product information relating to the device and corresponding to a product specified by the first product information obtained in the second obtaining step;
a generating step of generating the WEB page based on the first product information obtained in the second obtaining step and the second product information obtained in the third obtaining step; and
a transmitting step of transmitting the generated WEB page to the client terminal.

2. The method of controlling the screen generating server according to claim 1, wherein the distributor site is a site of a shop where the device has been purchased.

3. The method of controlling the screen generating server according to claim 1, wherein the parameter includes a serial number of the device and a number of a consumable in the device.

4. The method of controlling the screen generating server according to claim 1, wherein the first product information includes a product number and a first product price that is a price stored in the database.

5. The method of controlling the screen generating server according to claim 1, wherein the second product information includes a second product price that is a price in the distributor site.

6. The method of controlling the screen generating server according to claim 1, wherein the second product information includes a product page URL for purchasing a product corresponding to the product specified by the first product information in the distributor site.

7. The method of controlling the screen generating server according to claim 1, wherein the second product information includes information on whether a product is available.

8. The method of controlling the screen generating server according to claim 1, wherein, in the second obtaining step, a last access time of accessing the device is further obtained.

9. The method of controlling the screen generating server according to claim 8, wherein the first product information is a plurality of first product prices and the second product information is a plurality of second product prices.

10. The method of controlling the screen generating server according to claim 1, wherein the parameter includes region information.

11. The method of controlling the screen generating server according to claim 10, wherein, in the second obtaining step, the access information for a plurality of distributor sites is obtained based on the region information.

12. The method of controlling the screen generating server according to claim 1, wherein the predetermined device is a printer and the first product information and the second product information are information on an ink.

13. The method of controlling the screen generating server according to claim 1, wherein the access information is an application programming interface URL.

14. A product information providing system comprising a client terminal, a screen generating server configured to generate a WEB page based on a request from the client terminal, and a distributor site, wherein the screen generating server includes:
a first obtaining unit configured to obtain a parameter relating to a predetermined device from the client terminal in the case where the device is in a predetermined state;
a second obtaining unit configured to obtain first product information relating to the device and access information for obtaining information in a distributor site of the device, from a database storing information relating to the device based on the parameter obtained by the first obtaining unit;
a third obtaining unit configured to obtain second product information by using the access information, the second product information relating to the device and corresponding to a product specified by the first product information obtained by the second obtaining unit;
a generating unit configured to generate the WEB page based on the first product information obtained by the second obtaining unit and the second product information obtained by the third obtaining unit; and
a transmitting unit configured to transmit the generated WEB page to the client terminal.
